(19) United States
(12) Patent Application Publication
(10) Pub. No.: US 2022/0143771 A1
(43) Pub. Date: May 12, 2022

(54) AUTOMATIC SYSTEM FOR CUTTING TOOL INSPECTION AND REPLACEMENT

(71) Applicants: Leif Andreas Andersen, Kongsberg (NO); Davide Caputo, Kongsberg (NO)

(72) Inventors: Leif Andreas Andersen, Kongsberg (NO); Davide Caputo, Kongsberg (NO)

(21) Appl. No.: 17/435,525

(22) PCT Filed: Mar. 1, 2019
(86) PCT No.: PCT/IB2019/051663

§ 371 Date: Sep. 1, 2021

(51) Int. Cl. B23Q 17/09; B23Q 17/24; B23Q 3/155

(52) U.S. Cl. CPC B23Q 17/0909; B23Q 3/15546; B23Q 17/2457

(57) ABSTRACT

A method and an automatic system for evaluating the condition of a cutting tool insert in a machine tool comprising an inspection device and a processing software for tool wear evaluation. Such system comprises means for manipulating the cutting tool insert(s), replacing it/them when worn or broken, based on the assessment provided by the post processing software or based on user defined settings.

### TECHNICAL FIELD

The present invention relates to an automatic system for detecting the wear condition of cutting tools of a machine tool and a method thereof. In particular, the present invention relates to a system and method for automatically analyzing and eventually replacing broken and/or worn cutting tools of a metal cutting machine tool.

### BACKGROUND ART

During every machining process, due to the interaction between the tools and the workpiece, the tools get worn and need to be replaced before they break or, in general, before their state has a negative impact on the machining process' results, including the quality of the workpiece. The speed of this wear mechanism is dependent on many factors, and shows a significant variance. In conventional numerical controlled machine tools, machining processes are designed in order to avoid unnecessary stops for replacing the tools in the machine tool magazine.

The numerical control programmers accurately select the proper tools for the workpiece material and the desired process (i.e. drilling, boring, milling etc.) in order to have tools with a lifetime that is longer than the duration of the process. In this way, the tools keep their geometrical and mechanical characteristics during the machining process and therefore their performances are consistent during the cut. When this procedure is applied, the tools in the tool magazine do not have to be replaced during the machining process but only when the process is over.

In some cases, whenever the process is too long or the workpiece material is difficult to cut, it is impossible to find tools with a lifetime that is longer than the process duration; in such cases, in order to ensure a continuous process, one or many sister tools are used. A sister tool is here intended as a tool identical to the original tool; these sister tools are stored in the tool magazine and when the original tool gets worn during a machining process, they are picked up by the machine tool from the tool magazine and used for replacing the original tool in order to give continuity to the process.

Typically, the status of the original tool is not checked during the machining process; the lifetime of the tool is, in fact, estimated based only on the information provided by the tool manufacturers and validated during the machining process' design phase.

In such a design phase, often iteratively, the numerical control programmer simulates the process with a Computer-Aided Manufacturing (CAM) software and verifies the performances of the tool and the quality of the workpiece after the process. Through a series of tests, the programmer checks the real lifetime of the tool in the process conditions, controlling when the tool gets worn. Based on the information retrieved from the CAM, on general experience and on the tests done, the lifetime of the tool to be used in the process being designed is chosen and sometimes becomes a frozen parameter, in the sense that it is not changed anymore afterwards.

The tool's lifetime defines for how long the tool can be used in that process before being changed. The lifetime of the tool is an important parameter, because it must ensure that the tool is used enough to avoid scrapping it too early for minimizing the process cost and, at the same time, it must ensure that it is not used too much, incurring in all issues connected to tool wear and breakage. This in practice means that, for safety reasons, the lifetime assigned by the numerical control's programmer is always a conservative value, lower than the nominal tool lifetime (i.e. specified by the tool manufacturers), compared to the real lifetime possible to be obtained from a specific tool.

Once the tool's lifetime is selected by the programmer and the process is stable, the design phase is over and the production phase starts. In the production phase, the tool is systematically replaced once its lifetime (the one assigned by the programmer) is reached.

There are several strategies known in the art for tool replacements, but all of them involve manual processes. The replacement can be done for example (i) during the work shift (during the production, when another tool is used or a sister tool is operating), (ii) at a predefined time when all the used tools in the machine are changed (the entire tool magazine is emptied and refilled with new tools), (iii) at the end of the work shift, if the number of sister tools is high enough to ensure continuous operation during the whole work shift, etc. In every case, the operator has to withdraw the worn tool from the machine and replace it with a new one.

Several strategies are used nowadays in machining companies to maximize the tool lifetime and reduce the overall tooling cost.

As relevant prior art documents, US2018299865A1 discloses a method implemented in the numerical control for monitoring and controlling a machine tool during operation, which includes the evaluation of a signal provided by different sources containing information about the state of the tool (tool breakage, tool wear) and the execution of an appropriate counteraction via a dedicated numerical control program. A camera moved by a robot that can be triggered by the numerical control for evaluating the state of the tool is disclosed as a potential information source.

DE102012106139 (A1) describes a method for detecting tool wear, consisting of comparing the actual state of the tool with the original one by means of an optical device. The document includes the description of a device for implementing the method, which includes a camera which has to be positioned perpendicularly to the surface to be inspected; the inspection can be done while the tool is not in use and the camera can be positioned into the tool magazine. The document also mentions that the tool has to be cleaned before inspection with solid, liquid and gaseous means or adequate image processing software filters for correcting the picture. The system can be interfaced to the numerical control of the machine tool for correlating the pictures with the tool cutting parameters used in the process and replacing the tool when it is worn. The information about the tool original shape and its wear process can be stored in a database.

DE102014104581A1 presents a method for monitoring the tool wear similar to the one presented in DE102012106139, providing more details about the techniques for analyzing the wear, including colour analysis and volumetric analysis by means of multiple cameras and fringe projection methods. The tool is clamped on a tool holder during the inspection and can be cleaned with sodium hydroxide solution and dedicated tools.

Further, JP6203864B2 describes an automatic cutting system, which uses exchangeable round insert tool-type cutting tools and is equipped with control means which read a machining program, a database for storing service life test data and tool data and an automatic system for the tool's round insert rotation including a tool screw loosening mechanism for loosening the tool screw, a tool rotation mechanism for rotating the tool insert and a control device for controlling the tool insert screw loosening mechanism and the tool rotation mechanism. A camera is used for detecting the cutting tool insert position and for confirming the tool wear.

JP2012006119A describes in details a system for accurately adjusting the rotational position of a round-inserts cutting tools; the system includes means for unscrewing the tool insert and screwing it back once rotated.

With large lots and aggressive machining conditions, cutting tools will often become worn during a production shift; this happens even with smaller lots, i.e. when materials are difficult to machine. For this reason, most companies replace worn tools on a regular basis. The tool replacement process is typically a fully manual process, which requires an amount of time and effort proportional to the number of tools to be replaced and is closely related to how much disassembly is required to remove the cutting part of the tool. Time and effort can be quantified as a manufacturing cost, labor cost in particular, which despite being high, is necessary for all machining companies.

In addition to this cost, companies have to bear other costs related to the accidental breakage of the tools; besides tooling costs, the consequences of tool breakage can include part damage or even machine damages, which only occasionally occur but can be very high and therefore undesirable. Beside maintenance costs for replacing worn or broken machine parts, the consequences of tool breakage can involve the scrapping of damaged parts or the rework necessary when the tools wear up before their lifetime is reached.

Thus, the aim of the present invention is to provide a device and a method for automatically checking the wear status of tools in a machine tool thus prolonging their lifetime with no interference with the machining process.

### SUMMARY OF THE INVENTION

In a first aspect, the present invention refers to a system for detecting the wear condition of tool inserts of a machine tool such as that one indicated in claim 1.

The Applicants of the present application have in fact found that the above-mentioned technical problems can be effectively and reliably solved by means of a system for detecting the wear condition of the cutting tool inserts of a machine tool, each cutting tool insert being housed in a respective tool body of a tool holder in a machine tool magazine or in a confined space adapted to safely handle said tool holder, wherein the system comprises:
manipulating means able to pick up from said machine tool magazine or from said confined space one of said tool holders housing the tool insert(s) to be subjected to wear inspection;
a support detached from the machine tool able to stably holding said picked up tool holder;
an inspection device able to detect the wear condition data related to said cutting tool insert(s) housed in the picked-up tool holder;
a data management platform able to collect said detected wear condition data for each of said inspected cutting tool inserts;
a control unit able to evaluate the effective wear condition of said cutting tool inserts either directly or by comparing said detected wear condition data with a pre-established set of tool wear condition data;
means to a) eventually remove from the tool holder an integral cutting tool insert detected as worn by the wear inspection and to replace it with a new one, or to b) eventually remove from the tool holder an individual cutting tool insert detected by the wear inspection as having at least one not-worn cutting face and to eventually reposition it in said tool body of the tool holder so that said not-worn cutting face of the individual cutting tool insert is repositioned in an effective operative position.

By this way, the system allows to reduce the overall manufacturing costs of machining companies without interrupting the machining process when the tools are undergoing a wear inspection. The usage of the cutting tool inserts to the end of their real lifetime is thus maximized.

In one embodiment of the present invention, said tool holder housing said cutting tool insert to be wear inspected is placed in a machine tool magazine together with several other tool holders. In this embodiment, the manipulating means are able to pick up said tool holder from said machine tool magazine to subject the corresponding cutting tool insert to wear inspection.

In another embodiment of the present invention, said tool holder housing said cutting tool insert to be wear inspected is placed in an additional area where cutting tool insert tools to be replaced are made available to the operator in a confined space where the operator can safely handle them. In this embodiment, the manipulating means are able to pick up said tool holder from said confined space, rather than from the machine tool magazine as seen above.

According to a preferred embodiment of the present invention, said inspection device can be a camera, a laser scanner, a microscope, or similar devices, or any combination of such devices.

According to a preferred embodiment of the present invention, said cutting tool insert's wear condition data relates to color, dimension, volume, shape and geometrical characteristics of the cutting tool inserts surfaces.

According to a preferred embodiment of the present invention, said manipulating means comprise a robot able to move said tool holder, housing the tool insert(s), from said machine tool magazine or from said confined space to said support, where it is subjected to wear inspection.

According to a preferred embodiment of the present invention, said robot is provided with a wrist eventually bearing exchangeable end-effectors, selected according to the need.

By this way, the proper end-effector may be fixed, in turn, to the robot's wrist, according to the action to be executed.

According to one embodiment of the present invention, the proper end-effector is a gripper, such as a pneumatic expansion gripper, an electric or pneumatic multi jaw gripper, able to grab said tool holder while it is removed from said machine tool magazine, or from said confined space and to position it onto the support.

According to another embodiment of the present invention, the proper end-effector is a cleaning device, such as brush-like device, or other solid, liquid and gaseous means able to remove dirt and other impurities from the surface of the cutting tool insert to be subjected to inspection.

In this way, being the cutting tool insert cleaned before the wear inspection starts, any undesired impurity present on the surface of the cutting tool insert is removed so that it cannot negatively affect the wear inspection process performance.

According to a preferred embodiment of the present invention, said support for stably holding the picked-up tool holder is a rotating table. In this way, the rotation of the rotating table allows the tool holder fixed to the rotating table and housing the cutting tool insert to, accordingly, rotate in front of the inspection device in order to perform the cutting tool insert wear inspection. In alternative, according to another embodiment of the present invention, said robot is able to determine the movement, such as a rotation, of said inspection device around said tool holder housing the cutting tool insert to be subjected to wear inspection. In this way, such movement of the inspection device around the tool holder is performed while the tool holder is still clamped on the machine tool spindle.

According to a preferred embodiment of the present invention, said robot is connected to the inspection device and to said rotating table.

According to a preferred embodiment of the present invention, said robot is guided in its movements by said camera and, the rotating table provided with a rotary encoder or a similar system, is used for orienting the tool holder in repeatable predefined positions calculated for example based on the information retrieved by the camera and/or by the CAD model of the tool.

According to a first embodiment of the present invention, the cutting tool insert to be subjected to wear inspection is an individual cutting tool insert provided with a plurality of cutting faces.

In this way, said inspection device is able to detect the wear condition of each of said cutting faces of the cutting tool insert, independently one from each other.

According to a preferred aspect of said first embodiment, the system of the present invention further comprises means for removing the cutting tool insert from the tool holder and to reposition it in the tool body housing it in a configuration having a new orientation of the cutting faces of the cutting tool insert so that the cutting face of the cutting tool insert that is detected by the wear inspection as not-worn is positioned in an effective operative position.

According to a second embodiment of the present invention, the cutting tool insert to be subjected to wear inspection housed in the tool holder is an integral cutting tool insert, which is fastened on the tool holder.

In this way, replacing the cutting part of a worn integral cutting tool insert requires replacing the entire integral cutting tool insert, which can impact on the tool's dimensions, i.e. overall length and diameter.

According to a preferred aspect of said second embodiment, the system of the present invention further comprises means for calculating an offset for the correct utilization of the new integral cutting tool insert which replaces the worn one.

In this way, any change in dimensions of the not-worn integral cutting tool insert with respect to the replaced worn one may be compensated.

According to a preferred embodiment of the present invention, said system further contains collecting means for collecting any replaced worn cutting tool insert.

According to a preferred embodiment of the present invention, said system further contains a cutting tool insert container housing not yet used spare cutting tool inserts to be used to replace said worn detected cutting tool inserts.

According to a preferred embodiment of the present invention, said pre-established set of tool wear condition data is able to be updated each time at least one of said worn cutting tool inserts has been replaced by a new one.

According to a preferred embodiment of the present invention, said system further contains a graphical user interface able to show data related to the cutting tool wear evaluation, to the tool useful life statistics, and/or suggesting optimal tool replacement strategies.

In a second aspect, the present invention refers to a system for detecting the wear condition of tool inserts of a machine tool such as that one indicated in claim 13.

The Applicants of the present application have in fact found that the above-mentioned technical problems can be effectively and reliably solved by means of a method for automatically inspecting the wear condition of at least a cutting tool insert housed in a tool body of a tool holder of a machine tool, wherein the method utilizes the system as described above with reference to the first aspect of the present invention.

In particular, for each cutting tool insert to be wear inspected the method comprises the following phases:
a) picking up or receiving from a machine tool magazine, or from a confined space adapted to safely handle said tool holder, the tool holder housing the cutting tool insert to be inspected and transferring it to a detached support for stably holding the tool holder during the cutting tool insert wear inspection;
b) cleaning the cutting tool insert in the corresponding tool holder housing it;
c) detecting the wear condition data of said cutting tool insert;
d) collecting said wear condition data of the inspected cutting tool insert on a data management platform;
e) comparing said detected cutting tool insert wear condition data with a pre-established set of cutting tool insert wear condition data in order to establish its wear condition;
f) eventually removing from the tool holder: a) the integral cutting tool insert detected by the wear inspection as completely worn and replacing it with a new one, or b) the individual cutting tool insert which has at least one not-worn cutting face and eventually repositioning it in the tool body of the tool holder in such a way that said not-worn cutting face of the individual cutting tool insert is re-positioned in an effective operative position.

The method of the present invention can be applied by means of at least one device for inspecting the cutting tool insert and at least one device for manipulating the cutting tool insert which can be positioned in a defined area for performing the inspection and the cutting tool insert manipulation. Such an area can be for example inside the machine tool, in the proximity of the working area, in a defined area protected by any contaminant that can compromise the inspection and manipulation process (i.e. chips and coolant).

The method of the present invention eliminates the need of supervision during the cutting tool insert replacement tasks and therefore minimizes the overall manufacturing costs for machining companies.

Furthermore, the method of the present invention can be implemented in order to run all the replacement operations offline, while the machine tool is running another process; this minimizes the impact of the cutting tool insert replacement process on the machining process and enables longer machining times and therefore higher profits for the machining companies.

According to a preferred embodiment of the present invention, said method further comprises the phase of identifying said tool holder housing the cutting tool insert before the tool holder is picked-up and the wear inspection is started.

According to a preferred embodiment of the present invention, said phase of identifying said tool holder includes an interface with a numerical control whenever the automatic system is installed close to the working area, in proximity of the machine tool or in the tool magazine.

According to a preferred embodiment of the present invention, said numerical control communicates to the system several information including the number of cutting tool inserts, the position in the tool magazine, etc.

In this way, the inspection and replacement cycles are synchronized with the time schedule of the processes run in the machine.

According to a preferred embodiment of the present invention, said tool holder housing the cutting tool insert to be inspected is transferred to a table for stably holding the tool insert during the wear inspection. Preferably said table is a rotating table.

According to a preferred embodiment of the present invention, said rotating table is provided with an encoder for ensuring angular positioning accuracy and repeatability, illumination systems, tool magazines and any other tool which is useful for carrying out the inspection/replacement process.

According to a preferred embodiment of the present invention, said cutting tool insert to be subjected to wear inspection is identified before the wear inspection comes to a start.

According to a preferred embodiment of the present invention, said tool holder is identified by retrieving the tool number information from the machine tool numerical control or directly by scanning the barcode, serial number or other tool's identification codes or signs.

According to a preferred embodiment of the present invention, the effective position of the cutting tool insert(s) in the tool holder is checked by an inspection device, such as a camera, a laser scanner, a microscope, or similar devices, or a combination of such devices.

In this way, the picture(s) obtained by the camera allows to verify the effective position of the cutting tool insert in the respective holder in order to calibrate all the measurements.

According to a preferred embodiment of the present invention, said information related to the effective position of the cutting tool insert in the tool holder are communicated to a control unit able to compare said detected wear condition data with a pre-established set of tool wear condition data.

In this way, the angular position of the rotating table may be adjusted in order to compensate for possible deviations.

According to a preferred embodiment of the present invention, after being identified and before the starting of the wear inspection, said cutting tool insert to be subjected to wear inspection is cleaned to remove dirt and other impurities from the surface of the cutting tool insert. Several means can be used to perform this cleaning action such as brush or other solid, liquid and gaseous means.

According to a preferred embodiment of the present invention, once the cutting tool insert is completely clean, it can be inspected for evaluating its state and decide if any replacement has to be done.

According to a preferred embodiment of the present invention, said inspection phase further includes the phase to compare the cutting tool insert accumulated machining time to the tool lifetime defined by the end user for each tool or available on the data management platform for that tool. The tool lifetime is here intended as a predefined fixed value, such as for example the one provided by the cutting tool insert manufacturer, or obtained by using appropriate mathematical equations (i.e. Taylor and the like) linked to the cutting parameters used in the process.

If the lifetime is already reached or will be during the next interaction of the cutting tool insert in the machine tool, the tool insert has to be changed; otherwise, the cutting tool insert can be used again.

According to a preferred embodiment of the present invention, the evaluation is further accomplished by comparing the reference information of the cutting tool insert with the current one, acquired via the inspection device.

The reference information of the cutting tool insert is the one acquired before the first use of the system or the first use of the cutting tool insert, when the cutting tool insert is new.

According to a preferred embodiment of the present invention, the level of wear on the cutting tool insert is detected by bi-dimensionally analyzing the differences between the reference picture(s) and the current one(s) or by performing a volumetric analysis, which help identifying the presence of additional (or reduced) volumes on the original cutting tool insert surfaces.

According to a preferred embodiment of the present invention, the picture(s) or the features extracted from the picture(s) during the wear inspection are saved in the data management platform for tracking the cutting tool insert wear inspection process.

According to a preferred embodiment of the present invention, said phase of removing the cutting tool insert from the corresponding holder housing is accomplished by unscrewing the cutting tool insert from its corresponding holder.

According to a preferred embodiment of the present invention, the screw can be unscrewed by means of an electric or pneumatic screwdriver; the size of the screw is calculated based on the images taken by the camera or retrieved from the cutting tool insert information stored in the data management platform and an adequate screwdriver or screwdriver bit is selected for carrying out the unscrewing operation. The orientation and the position of the screwdriver can be calculated by using the information gathered via the camera; this information is then stored in the data management platform when the reference information of the cutting tool insert is acquired and used automatically in the following inspections for reducing the cutting tool insert replacement time.

According to a first embodiment of the method of the present invention, when said individual cutting tool insert comprises a plurality of cutting faces, said phase c) relates to detect the wear condition of each of said plurality of cutting faces of the cutting tool insert, independently one from each other.

In case at least one of said plurality of cutting faces of the individual cutting tool insert subjected to inspection is not worn, said phase e) consists in re-orienting the cutting faces of the individual cutting tool insert so that the cutting face of the individual cutting tool insert that is detected by the wear inspection or by the data management platform as not-worn is positioned in an effective operative position in the insert holder.

In this way, after the inspection has detected that the cutting face of the individual cutting tool insert which was active in the machine tool is worn, and that at least another cutting face of the same individual cutting tool insert is not worn, the individual cutting tool insert is first removed from the tool insert holder and then re-positioned in it in such a configuration that the not-worn cutting face allows the individual cutting tool insert to properly work again in the machine tool. The individual cutting tool insert has to be repositioned in its original slot on the tool holder and screwed back. Once the individual cutting tool insert is leaning on the tool holder in the reference position, and the holes of the individual cutting tool insert and of the tool holder are concentric, the individual cutting tool insert is fastened by using a screw and a screwdriver.

This process can be repeated for all the individual cutting tool inserts housed in the tool insert holder. Once all the inspection and replacement cycles are completed, all the individual cutting tool inserts on the tool holder are positioned in order to have new cutting faces ready to be used for the next machining process.

In case, on the contrary, all said plurality of cutting faces of the individual cutting tool insert subjected to inspection are worn, the worn individual cutting tool insert is discarded and replaced by a new one.

According to a second embodiment of the method of the present invention, when said cutting tool insert consists of an integral cutting tool insert that results to be worn after being subjected to said wear inspection, the entire integral cutting tool insert is discarded and replaced by a new one.

In this way, when replacing a worn integral cutting tool insert with a new one, the integral cutting tool insert dimensions in the tool holder may change; in this case, according to a preferred embodiment of the present invention, the method also includes the phase to measure and calculate an offset during the worn integral cutting tool insert replacement.

According to a preferred embodiment of the present invention, said discarded worn cutting tool inserts are collected in a suitable cutting tool insert collecting means, such as tool bins, for scrapping or recoating purposes, both in the case the discarded worn cutting tool insert consists of an individual cutting tool insert having a plurality of cutting faces, as disclosed above in the first embodiment of the present invention, or in the case it is an integral cutting tool insert, as disclosed above in the second embodiment of the present invention.

According to a preferred embodiment of the present invention, said new cutting tool insert used to replace the worn discarded cutting tool insert is taken by a suitable gripping device from a container housing new spare cutting tool inserts of the same type of the cutting tool inserts used in the machine tool.

According to a preferred embodiment of the present invention, said suitable gripping device are pneumatic expansion gripper, electric or pneumatic multi jaw gripper for internal diameters or the like.

According to a preferred embodiment of the present invention, once all the tool cutting tool inserts are ready to be used again, all the necessary information retrieved in the process is stored in the data management platform.

According to a preferred embodiment of the present invention, when the inspection/replacement process is over a signal is sent to the numerical control of the machine tool or to the operator.

In this way, the availability of the tool insert for the next machining operation is confirmed.

According to a preferred embodiment of the present invention, the results of the evaluations are saved in a data management platform and kept for further analyses. According to a preferred embodiment of the present invention, once a sufficient amount of data on the wearing process of the cutting tool inserts in a particular machining process is available, the system performs a statistical analysis in order to extend the knowledge of the machining process and provides to the user some suggestions on how to optimize the usage and the replacement of the cutting tools inserts in order to minimize costs and processing times, increase safety of operation and/or other key performance indicators defined by the user.

According to a preferred embodiment of the present invention, this information is made available by the system to the user via a graphical user interface at the machine. In an alternative embodiment of the present invention, the same information is made available also remotely via a dedicated application developed both for mobile devices and for PCs.

According to a preferred embodiment, the method of the present invention further comprises the phase of interfacing to other company systems, such as ERP or process monitoring systems, to provide suggestions for improving/adapting the estimation of the effective tool life of the cutting tool inserts.

According to a preferred embodiment, the method of the present invention further comprises the phase of monitoring the stability of the cutting process in the machine tool.

According to a preferred embodiment of the present invention, the method also issues and sends periodic reports to the user.

Further characteristics and advantages of the present invention will be better highlighted by examining the following detailed description of a preferred but not exclusive embodiment, illustrated by way of non-limiting examples, with the support of the attached drawings, in which:

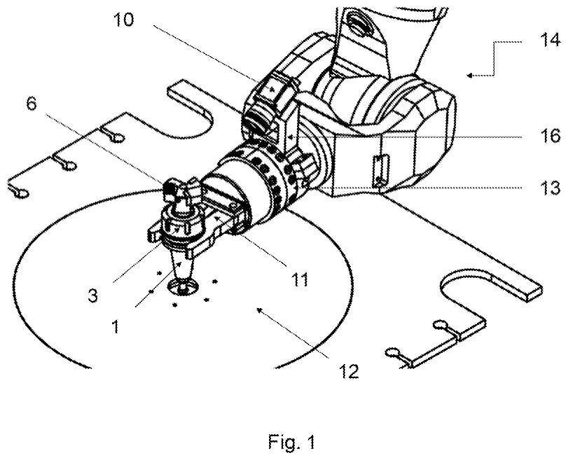

FIG. 1 schematically shows a tool holder being placed onto a rotary table for wear inspecting the cutting tool insert(s) housed in the tool holder;

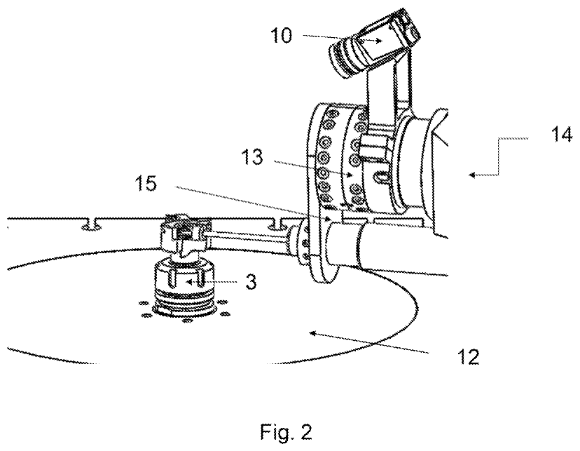

FIG. 2 shows a robot provided with an end-effector with an insert cleaning brush;

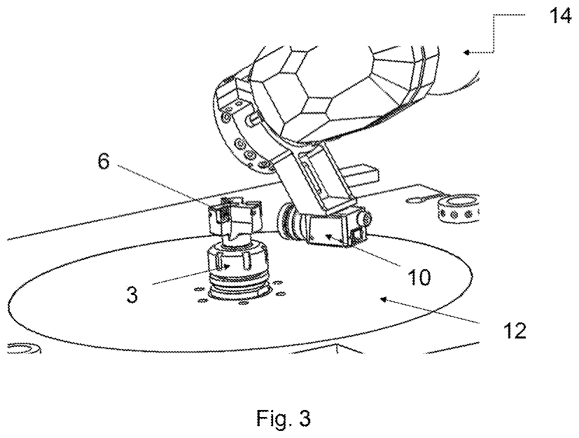

FIG. 3 shows the cutting tool insert shown in FIG. 2 subjected to wear inspection by a camera;

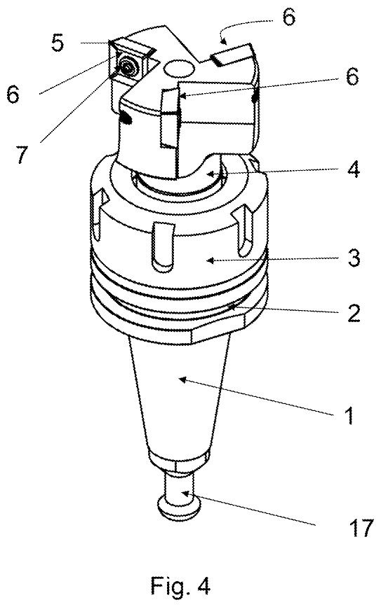

FIG. 4 shows an individual cutting tool insert with three inserts, each of them having four cutting faces;

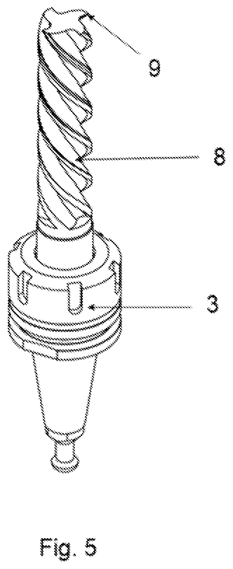

FIG. 5 shows an integral cutting tool element with four cutting faces.

### DETAILED DESCRIPTION OF THE INVENTION

The following detailed description refers to particular embodiments of the cutting tool insert inspection/replacement system and related method of the present invention shown in FIGS. from 1 to 5, without limiting its content.

With particular reference to FIGS. from 1 to 4 a first embodiment of the system comprises a rotating table 12 able to stably hold a picked-up tool holder 3 bearing individual cutting tool inserts 6 during a wear inspection. The system further comprises a robot 14 provided with a wrist 13 to which a gripper 11 for holding the tool holder 3 and for positioning it onto the rotating table 12 has been fixed. A camera 10 is fixed to the robot 14 through a support arm 16; the camera 10 is used as an inspection device to detect the wear condition of the individual cutting tool insert 6.

FIG. 2 shows the same system of FIG. 1 wherein the wrist 13 is equipped with a brush-like end-effector 15 (rather than the gripper 11 shown in FIG. 1) able to remove dirt and other impurities from the surface of the individual cutting tool insert 6 before subjecting it to wear inspection, while FIG. 3 shows the same system of FIG. 1 wherein all end-effectors are removed from the wrist 13 of the robot 14 in order to render easier the wear inspection accomplished by the camera 10.

The tool holder 3 bearing the individual cutting tool insert 6 is shown in detail in FIG. 4, wherein the tool holder includes the shank 1, which is fixed to the rotating table 12 through the lower protuberance 17, and the flange 2, which is used for handling the tool holder 3. Furthermore, the tool body 4 allows the tool holder 3 to bear the individual cutting tool insert 6. In FIG. 4 three individual cutting tool inserts 6 are shown, each of them has four cutting faces 5 and a fixing screw 7.

Operatively, the wear inspection procedure of the individual cutting tool insert 6 starts by the numerical control whenever the automatic system is installed close to the working area, in proximity of the machine tool or in the tool magazine. The numerical control communicates to the system several information including the individual cutting tool insert ID number and the position in the tool magazine. The individual cutting tool insert is identified by retrieving the tool number information from the machine numerical control, or directly via RFID, or by scanning with the camera 10 the tool's quick response code (QR), barcode, or serial number.

The tool holder 3 bearing the individual cutting tool insert 6 is picked from its position on the tool magazine of the machine tool by the gripper 11 fixed to the wrist 13 of the robot 14, as shown in FIG. 1. Then, the tool holder 3 is positioned onto the rotating table 12. The individual cutting tool insert 6 has to be cleaned, removing the unwanted material from the tool surface. To this end, the gripper 11 is removed from the wrist 13 of the robot 14 and replaced by the brush 15 as shown in FIG. 2. Once the individual cutting tool insert 6 is completely clean, the brush 15 is removed from the wrist 13 of the robot 14 and the wear inspection through the camera 10 starts.

The evaluation can be done by comparing the reference information of the individual cutting tool insert 6 (in the same position) with the current one, acquired via the inspection device or it may be done by a direct measurement of the wear. The reference information of the individual cutting tool insert 6 is the one acquired before the first use of the system or the first use of the individual cutting tool insert 6, when it is new. The presence of wear on the individual cutting tool insert 6 is detected by analyzing the differences between the reference picture(s) and the current one(s) taken by the camera 10.

The picture(s) or the features extracted from the picture(s) taken by the camera 10 during the analysis are saved in the data management platform for tracking updated information about the wear development process of the individual cutting tool insert 6.

The individual cutting tool insert 6 accumulated machining time is compared to the tool lifetime defined by the end user or available on the data management platform for that individual cutting tool insert 6. The lifetime of the individual cutting tool insert 6 is here intended as a predefined fixed value.

If the lifetime is already reached or will be reached in few machining cycles, the individual cutting tool insert 6 has to be changed; otherwise, the individual cutting tool insert 6 can be used again.

In case the individual cutting tool insert 6 is to be replaced, it must be removed from the tool body 4. This operation involves the unscrewing of the screw 7 which fixes the individual cutting tool insert 6 to the tool insert holder 3 in operating conditions. The screwdriver may be an electric or pneumatic screwdriver; the size of the screw is calculated based on the images of the camera 10 or retrieved from the tool information stored in the data management platform and an adequate screwdriver or screwdriver bit is selected for carrying out the unscrewing operation. The direction and the position of the screwdriver can be calculated by using the information gathered via the camera 10; this information can be advantageously stored in the data management platform when the reference information of the individual cutting tool insert 6 is acquired and used automatically in the following inspections for reducing the individual cutting tool insert 6 replacement time.

Then, the worn individual cutting tool insert 6 is picked up by means of a dedicated gripper (not shown) and positioned in a suitable collecting means for collecting any replaced worn individual cutting tool insert 6. A new individual cutting tool insert 6 of the same type of the discarded worn one, is picked up from a tool insert storage, housing a plurality of individual cutting tool inserts 6 by using the same gripper used for picking the worn individual cutting tool insert 6. The system can include information on the level of each tool insert storage, in order to communicate to the operator when to refill it with additional individual cutting tool inserts 6.

In the particular embodiment of the present invention shown in FIG. 4, the individual cutting tool insert 6 is of the indexable type, that means it is constituted by a plurality of cutting faces 5. In this case, the wear inspection procedure checks all the cutting faces 5 of the individual cutting tool insert 6, or data on tool faces status are retrieved from the data management platform. If all the cutting faces 5 are worn, then the indexable individual cutting tool insert 6 cannot be used anymore and is to be replaced. If, on the contrary, at least one cutting face 5 is not worn, the automatic system re-orients the individual cutting tool insert 6 in such a configuration that the selected cutting face 5 can be used in the next machining operation.

This inspection and replacement process is repeated for all the individual cutting tool inserts 6 in the tool holder 3.

When the inspection/replacement process is over, a signal is sent to the numerical control of the machine or to the operator, confirming the availability of the tool for the next machining operation.

Once all the individual cutting tool inserts 6 are ready to be used again because new or not completely worn, all the necessary information retrieved in the process are stored in the data management platform and kept for further analyses. Once a sufficient amount of data on the wearing process of the individual cutting tool inserts 6 in a particular machining process is available, the system performs a statistical analysis and provides to the user some suggestions on how to optimize the usage and the replacement of the individual cutting tool inserts 6 in order to minimize costs, processing times or other key performance indicators defined by the user. This information is made available by the system to the user via a graphical user interface at the machine, but the same information can be made available also remotely via a dedicated app developed both for mobile devices and for PCs. The system can also issue and send periodic reports to the user.

With particular reference to FIG. 5 a second embodiment of tool holder 3 is shown; in this embodiment, the insert tool is an integral cutting tool insert 8, that means it is realized by a single block which is fastened on the tool holder 3, and bears four cutting faces 9.

When the integral cutting tool insert 8 is worn, the cutting faces 9 can be replaced only by replacing the whole integral cutting tool insert 8. In this case, since every time they are replaced their dimensions can vary with respect to those of a reference integral cutting tool insert 8, the method includes the phase to measure and calculate an offset during the replacement of the worn integral cutting tool insert 8. The measurement of the dimensions of the new integral cutting tool insert 8 is known as tool presetting and the difference between the reference values and the measured value is communicated to the numerical control of the machine before the integral cutting tool insert 8 is used in the next process.

Naturally, many modifications and variations of the described preferred embodiments will be evident to those skilled in the art, still remaining within the scope of the invention.

Therefore, the present invention is not limited to the preferred embodiments described, illustrated only by way of non-limiting example, but is defined by the following claims.

1. An automatic system for detecting a wear condition of cutting tool inserts of a machine tool, each cutting tool insert being housed in a respective tool body of a tool holder in a machine tool magazine or in a confined space adapted to safely handle said tool holder, wherein the system comprises:
manipulating means able to pick up from said machine tool magazine or from said confined space one of said tool holders housing the cutting tool insert/s to be subjected to wear inspection;
a support detached from the machine tool able to stably holding said picked up tool holder;
an inspection device able to detect the wear condition data related to said cutting tool insert/s housed in the picked up tool holder;
a data management platform able to collect said detected wear condition data for each of said inspected cutting tool inserts;
a control unit able to (i) evaluate the effective wear condition of said cutting tool insert either directly or by comparing said detected wear condition data with a pre-established set of tool wear condition data; and
means to a) eventually remove from the tool holder an integral cutting tool insert detected as worn by the wear inspection and to replace it with a new one, or to b) eventually remove from the tool holder an individual cutting tool insert detected by the wear inspection as having at least one not-worn cutting face and to eventually reposition it in said tool body of the tool holder so that said not-worn cutting face of the individual cutting tool insert is repositioned in an effective operative position.

2. The automatic system as set forth in claim 1 wherein said manipulating means comprise a robot provided with a wrist eventually bearing removable end-effectors, such as a gripper able to grab said tool holder while it is removed from said machine tool magazine or from said confined space and positioned onto the support, or such as a brush-like device, or other solid, liquid and gaseous means able to remove dirt and other impurities from the surface of the cutting tool insert to be subjected to inspection.

3. The automatic system as set forth in claim 1 wherein said inspection device is a camera, a laser scanner, a microscope, or similar devices, or any combination of such devices.

4. The automatic system as set forth in claim 1 wherein said support for stably holding the picked-up tool holder is a rotating table.

5. The automatic system as set forth in claim 2 wherein said robot is able to move said inspection device around said tool holders housing the cutting tool insert to be subjected to wear inspection.

6. The automatic system as set forth in claim 1 wherein said cutting tool insert to be subjected to wear inspection housed in the tool body of the tool holders is an individual cutting tool insert provided with a plurality of cutting faces whose wear condition are detected independently one from each other.

7. The automatic system as set forth in claim 1 wherein said cutting tool insert to be subjected to wear inspection housed in the tool holder is an integral cutting tool insert, which is fastened on the tool holder.

8. The automatic system as set forth in claim 7 which further comprises means for calculating an offset for the correct utilization of the new integral cutting tool insert which replace the worn one.

9. The automatic system as set forth in claim 1 which further contains collecting means for collecting any replaced worn cutting tool insert.

10. The automatic system as set forth in claim 1 which further contains a cutting tool insert container housing not yet used spare cutting tool inserts to be used to replace said worn detected cutting tool inserts.

11. The automatic system as set forth in claim 1 wherein said pre-established set of tool wear condition data is able to be updated each time at least one of said worn cutting tool insert has been replaced by a new one.

12. The automatic system as set forth in claim 1 which further contains a graphical user interface able to show data related to the cutting tool insert wear evaluation, to the tool useful life statistics, and/or suggesting optimal tool replacement strategies.

13. A method for automatically inspecting a wear condition of at least a cutting tool insert housed in a tool body of a tool holder of a machine tool, wherein for each cutting tool insert to be wear inspected the method comprises:
a) picking up, or receiving from a machine tool magazine or from a confined space adapted to safely handle said tool holder, the tool holder housing the cutting tool insert to be inspected and transferring it to a detached support for stably holding the tool holder during the cutting tool insert wear inspection;
b) cleaning the cutting tool insert held in the corresponding tool holder housing it;
c) detecting the wear condition data of said cutting tool insert;
d) collecting said wear condition data of the inspected cutting tool insert on a data management platform;
e) comparing said detected cutting tool insert wear condition data with a pre-established set of cutting tool insert wear condition data in order to establish its wear condition;
f) eventually removing from the tool holder a) the integral cutting tool insert detected by the wear inspection as completely worn and replacing it with a not-worn one, or b) the individual cutting tool insert which has at least one not-worn cutting face and eventually repositioning it in the tool body of the tool holder in such a way that said not-worn cutting face of the individual cutting tool insert is re-positioned in an effective operative position.

14. The method as set forth in claim 13 which further comprises identifying said tool holder housing the cutting tool insert before the wear inspection starts.

15. The method as set forth in claim 13 wherein, when said individual cutting tool insert comprises a plurality of cutting faces, said detecting relates to detect the wear condition of each of said plurality of cutting faces.

16. The method as set forth in claim 13 wherein, when said cutting tool insert consists of an integral cutting tool insert that results to be worn after being subjected to said wear inspection, the entire integral cutting tool insert is discarded and replaced by a new one.

17. The method as set forth in claim 13 which further comprises statistically analyzing the data collected during the wear inspection of said cutting tool inserts in order to extend the knowledge of a machining process and provide further optimization.

18. The method as set forth in claim 13 which further comprises interfacing to other company systems, such as ERP or process monitoring systems, to provide suggestions for improving/adapting the estimation of an effective tool life of the cutting tool inserts.

19. The method as set forth in claim 13 which further comprises monitoring stability of a cutting process in the machine tool.

20. The method as set forth in claim 13 where tool wear inspection and tool inserts replacement are performed while the tool holder is still clamped on a machine tool spindle.
